(19) United States
(12) Patent Application Publication
(10) Pub. No.: US 2003/0236754 A1
(43) Pub. Date: Dec. 25, 2003

(54) Method, system, and computer program for identifying and classifying EDI and proprietary transactions

(76) Inventor: Bryan D. Thompson, Plano, TX (US)

Correspondence Address: Stephen R. Loe, P.O. Box 649, Frisco, TX, 75034, US

(21) Appl. No.: 10/425,132

(22) Filed: Apr. 28, 2003

Related U.S. Application Data
(60) Provisional application No. 60/381,424, filed on May 17, 2002.

(51) Int. Cl. H04L 9/00

(52) U.S. Cl. 705/64; 713/201

(57) ABSTRACT

A method, system, and computer program product for identifying a transaction type and sending and receiving trade partner identities in an electronic commerce transaction is provided. In one embodiment of the present invention, a transaction is received from a sending trade partner. A sample of the transaction is examined to determine key identifying characteristics. Using the key identifying characteristics, a transaction type is identified. A rule, chosen from a plurality of rules based upon the transaction type, is applied to the transaction to identify the sending and receiving trader partners.

### PRIORITY

This application claims the benefit of the filing date of corresponding U.S. Provisional Patent Application Serial No. 60/381,424, entitled “Method for identifying and classifying EDI and proprietary transactions (Adapter)”, filed May 17, 2002, the contents of which are hereby incorporated herein for all purposes.

### BACKGROUND OF THE INVENTION

1. Technical Field

The present invention relates generally to the field of computer software and, more specifically, to electronic commerce.

2. Description of Related Art

The “Internet” is a worldwide network of computers. Today, the Internet is made up of more than 65 million computers in more than 100 countries covering commercial, academic and government endeavors. Originally developed for the U.S. military, the Internet became widely used for academic and commercial research. Users had access to unpublished data and journals on a huge variety of subjects. Today, the Internet has become commercialized into a worldwide information highway, providing information on every subject known to humankind.

The Internet's surge in growth in the latter half of the 1990s was twofold. As the major online services (AOL, CompuServe, etc.) connected to the Internet for e-mail exchange, the Internet began to function as a central gateway. A member of one service could finally send mail to a member of another. The Internet glued the world together for electronic mail, and today, the Internet mail protocol is the world standard.

Secondly, with the advent of graphics-based Web browsers such as Mosaic and Netscape Navigator, and soon after, Microsoft's Internet Explorer, the World Wide Web took off. The Web became easily available to users with PCs and Macs rather than only scientists and hackers at UNIX workstations. Delphi was the first proprietary online service to offer Web access, and all the rest followed. At the same time, new Internet service providers rose out of the woodwork to offer access to individuals and companies. As a result, the Web has grown exponentially providing an information exchange of unprecedented proportion. The Web has also become “the” storehouse for drivers, updates and demos that are downloaded via the browser.

One area of the Internet that has continued to evolve rapidly is electronic commerce, which is the process through which business partners exchange information electronically. (It should be noted, however, that although that Internet is one powerful force in pushing the capabilities and use of electronic commerce, electronic commerce is not limited to the Internet, but may be implemented in a number of ways such as, for example, through a private intranet.) This exchange of information provides tremendous cost and time efficiencies for companies. Electronic commerce not only allows for paper records to be replaced by electronic documents, but also allows companies to dynamically enable and perform strategic business functions such as just-in-time manufacturing, supply chain management, efficient customer response, and vendor-managed inventory. Common business documents and processes between companies like purchase orders, invoices, and payments can now be totally automated when built into existing applications. This linking of customers and suppliers is changing the way the world does business, and fostering lasting, strong relationship between companies.

The most widely used way to implement electronic commerce is Electronic Data Interchange (EDI). EDI is the electronic exchange of business information between organizations in a structured format. However, because many different languages and formats are used by various companies, an electronic commerce switch is necessary to facilitate communication between one trading partner and another. An electronic commerce switch accepts many different transaction types from its trade partners. The transactions can be one of many EDI standard formats or proprietary formats. The switch must analyze the transaction's data content and identify the transaction standard and version for each transaction. Once the transaction format is known, a number of identifiers contained in the transaction data must be extracted from the transaction data, such as the transaction's sender and receiver. In addition, some transaction formats do not provide identifiers for a transaction's sender and/or receiver. In these cases, the switch must recognize these transactions and perform special logic to generate these identifiers.

Historically, most electronic commerce switches have solved these problems by creating a separate program or piece of code to deal with each transaction format as illustrated in FIG. 1. This leads to a large amount of code that can become unmanageable very quickly. For example, every new transaction format requires a programmer to write a piece of code 106-114 and that code 106-114 has to be certified and released into a production environment. Every transaction 102 received must have the transaction standard identified 104 and call the appropriate piece of code 106-114. Therefore, it would be desirable to have an electronic commerce switch which facilitates communication between trading partners using different transaction formats without resorting to writing a piece of code for every new transaction format.

### SUMMARY OF THE INVENTION

The present invention provides a method, system, and computer program product for identifying a transaction type and sending and receiving trade partner identities in an electronic commerce transaction. In one embodiment of the present invention, a transaction is received from a sending trade partner. A sample of the transaction is examined to determine key identifying characteristics. Using the key identifying characteristics, a transaction type is identified. A rule, chosen from a plurality of rules based upon the transaction type, is applied to the transaction to identify the sending and receiving trader partners.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a process flow diagram for a prior art method of identifying a transaction standard, trade partner, and transaction type for an electronic commerce transaction;

FIG. 2 depicts a pictorial representation of a distributed data processing system in which the present invention may be implemented;

FIG. 3 depicts a block diagram of a data processing system that may be implemented as a server in accordance with the present invention;

FIG. 4 depicts a block diagram of a data processing system in which the present invention may be implemented;

FIG. 5 depicts a flowchart illustrating process flow and program function for identifying a trade partner and transaction in accordance with one embodiment of the present invention; and

FIG. 6 depicts a block diagram of an exemplary Electronic Commerce Matching Service in accordance with one embodiment of the present invention.

### DETAILED DESCRIPTION OF THE PREFERRED EMBODIMENT

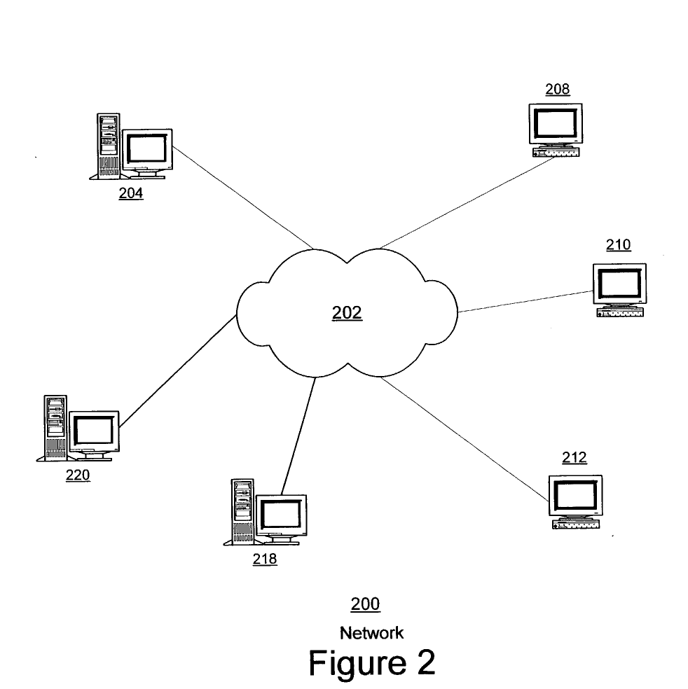

With reference now to the figures, and in particular with reference to FIG. 2, a pictorial representation of a distributed data processing system is depicted in which the present invention may be implemented.

Distributed data processing system 200 is a network of computers in which the present invention may be implemented. Distributed data processing system 200 contains network 202, which is the medium used to provide communications links between various devices and computers connected within distributed data processing system 200. Network 202 may include permanent connections, such as wire or fiber optic cables, or temporary connections made through telephone connections.

In the depicted example, switch server 204 is connected to network 202, along vendor servers 218 and 220. In addition, vendor trading partner clients 208, 210 and 212 are also connected to network 202. These clients, 208, 210 and 212, may be, for example, personal computers or network computers. For purposes of this application, a network computer is any computer coupled to a network that receives a program or other application from another computer coupled to the network. In the depicted example, switch server 204 facilitates electronic commerce between a vendor and its trading partners by facilitating communication between vendor server 218 or 220 and one of trading partner clients 208-212. Distributed data processing system 200 may include additional servers, clients, and other devices not shown.

Switch server 204 is an electronic clearing house that receives various electronic commerce documents, such as, for example, purchase orders, healthcare claims, etc., from various sources and routes the electronic documents to the appropriate destination. For example, clients 208-212 may represent the data processing components of healthcare provider businesses, such as physicians, and vendor servers 218 and 220 may be the data processing components of two different insurance providers.

For example, client 208, representing health care provider A, may wish to send a healthcare claim to insurance company A's server 218. Thus, client 208 sends the healthcare claim to switch server 204. Switch server 204 receives the healthcare claim and determines the identity of the sender and of the recipient and then forwards the healthcare claim to the appropriate recipient, which in the present example is server 218.

Because each vendor and trading partner may use different protocols, switch server 204 must recognize the protocol being utilized by a particular message and parse the message to determine the recipient and the sender. If switch server 204 is unable to determine the recipient, then switch server sends a notification to the sender indicating that the switch server 204 was unable to deliver the message because the recipient could not be identified.

In the depicted example, distributed data processing system 200 is the Internet, with network 202 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 200 also may be implemented as a number of different types of networks such as, for example, an intranet or a local area network.

FIG. 2 is intended as an example and not as an architectural limitation for the processes of the present invention.

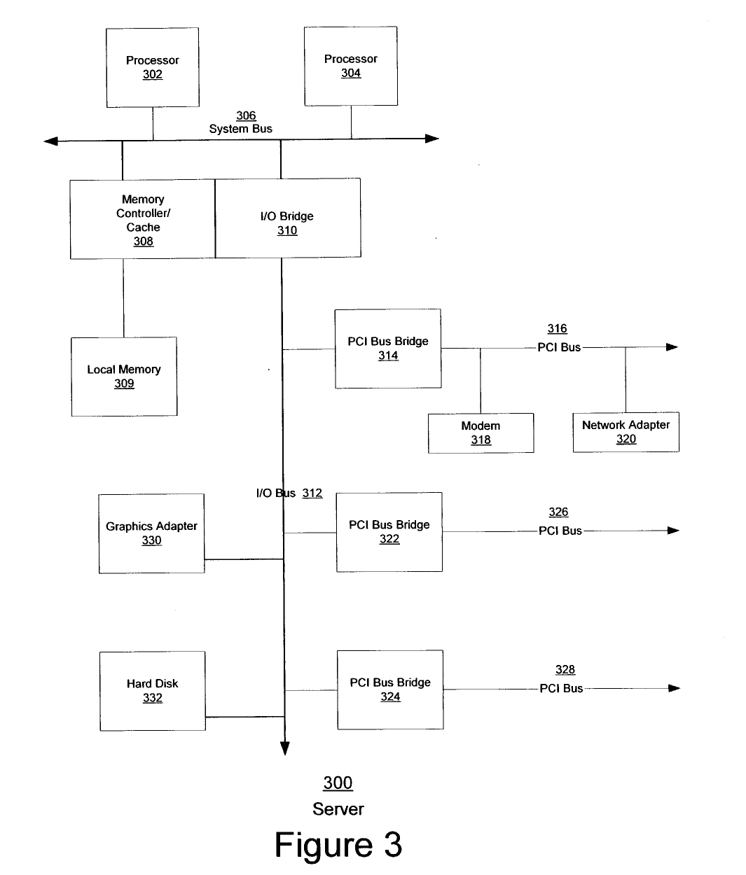

Referring to FIG. 3, a block diagram of a data processing system which may be implemented as a server, such as server 204, 218, or 220 in FIG. 2, is depicted in accordance with the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

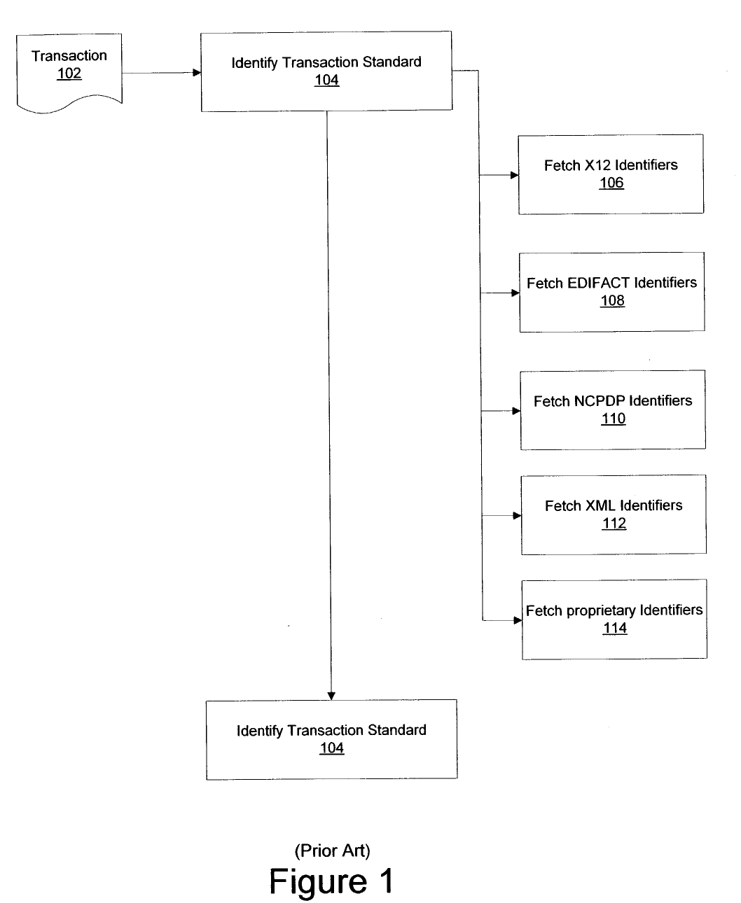

Peripheral component interconnect (PCI) bus bridge 314 connected to I/O bus 312 provides an interface to PCI local bus 316. A number of modems 318-320 may be connected to PCI bus 316. Typical PCI bus implementations will support four PCI expansion slots or add-in connectors. Communications links to network computers 108-112 in FIG. 1 may be provided through modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, server 300 allows connections to multiple network computers. A memory mapped graphics adapter 330 and hard disk 332 may also be connected to I/O bus 312 as depicted, either directly or indirectly.

Data processing system 300 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

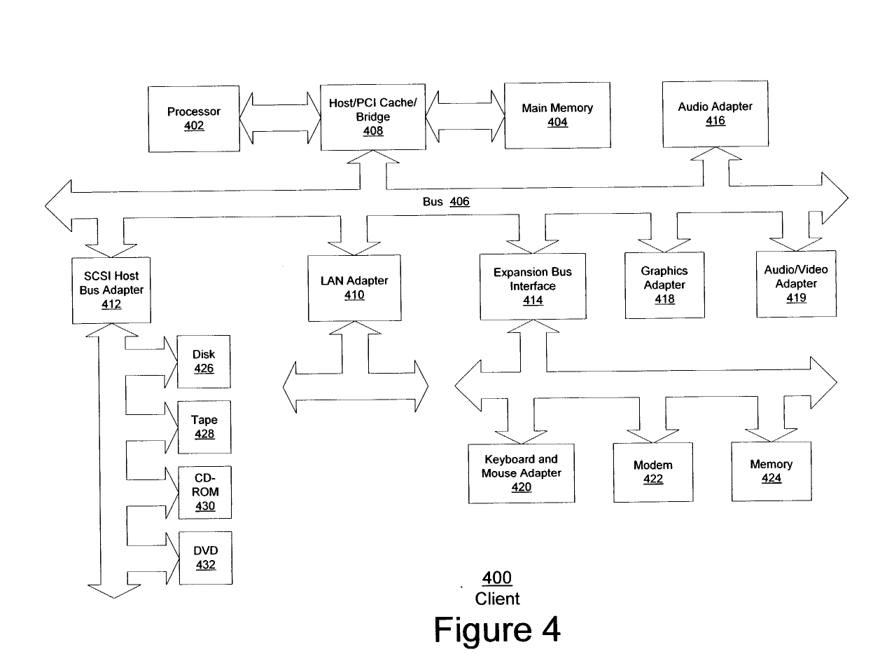

With reference now to FIG. 4, a block diagram of a data processing system in which the present invention may be implemented is illustrated. Data processing system 400 is an example of a client computer, such as any one of clients 108-112 in FIG. 1. Data processing system 400 employs a peripheral component interconnect (PCI) local bus architecture. Although the depicted example employs a PCI bus, other bus architectures, such as Micro Channel and ISA, may be used. Processor 402 and main memory 404 are connected to PCI local bus 406 through PCI bridge 408. PCI bridge 408 may also include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter (A/V) 419 are connected to PCI local bus 406 by add-in boards inserted into expansion slots. Expansion bus interface 414 provides a connection for a keyboard and mouse adapter 420, modem 422, and additional memory 424. In the depicted example, SCSI host bus adapter 412 provides a connection for hard disk drive 426, tape drive 428, CD-ROM drive 430, and digital video disc read only memory drive (DVD-ROM) 432. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 400. Instructions for the operating system, the object-oriented operating system, and applications or programs are located on a storage device, such as hard disk drive 426, and may be loaded into main memory 404 for execution by processor 402.

Those of ordinary skill in the art will appreciate that the hardware in FIG. 4 may vary depending on the implementation. For example, other peripheral devices, such as optical disk drives and the like, may be used in addition to or in place of the hardware depicted in FIG. 4. The depicted example is not meant to imply architectural limitations with respect to the present invention. For example, the processes of the present invention may be applied to multiprocessor data processing systems.

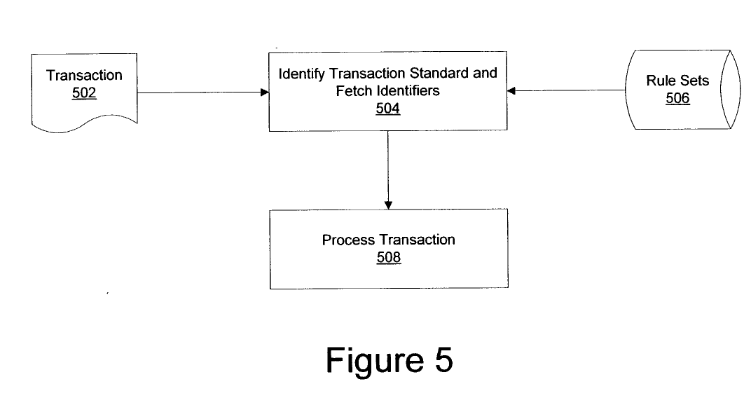

With reference now to FIG. 5, a flowchart illustrating process flow and program function for identifying a trade partner and transaction is illustrated in accordance with one embodiment of the present invention. In this embodiment, a transaction 502 is received from a trade partner. An adapter for an electronic commerce service identifies the transaction standard and fetches the appropriate identifiers 504 from the rule sets 506. The rule sets 506 are a set of rules that allows the adapter to parse the transaction to identify the trade partner and the transaction type without resorting to calling a module specifically coded to read transactions of a given type. The transaction standards may be, for example, one of many EDI standard formats or proprietary formats. Once the appropriate set of rules are determined, the rules are applied to process the transaction 508 in order to identify the trade partner and the transaction type. The transaction type may be, for example, a purchase order, a health care claim, or an invoice. The trade partner identity and transaction type are then forwarded to other components within the electronic commerce service for further processing.

By applying a set of rules in a single adapter to parse various types of transaction standards for trade partner identity and transaction type rather than calling a different one of several routines, each written specifically for a specific transaction standard, considerable savings in programming time is achieved. In the prior art, each transaction standard required that a programmer program a routine specifically for that transaction type in order for the transaction type to be parsed for the trade partner identity and the transaction type. In the present invention, the adapter incorporates a set of rules that allow the adapter to determine the trade partner identity and the transaction type without calling a specially written routine. All that is required is that the set of rules be updated every time a new transaction standard is implemented. Such updating requires significantly less time for a programmer than does writing a separate routine. The savings in time is on the order of 1/X where X is the number of transaction standards.

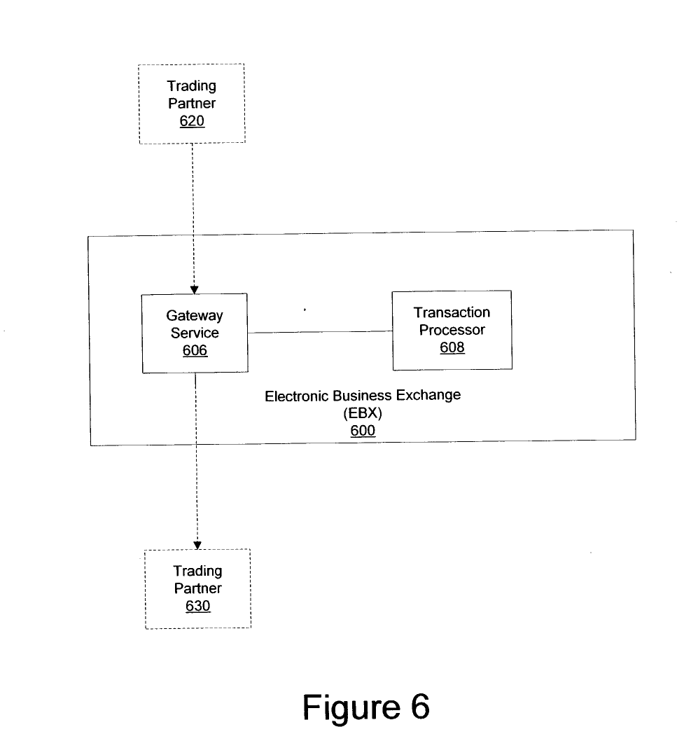

With reference now to FIG. 6, a block diagram of an exemplary electronic business exchange system (i.e., an electronic commerce matching service system) is depicted in accordance with one embodiment of the present invention. The electronic business exchange (EBX) system 600 may be implemented in a server, such as, for example, server 204 in FIG. 2. EBX 600 includes a gateway/delivery service 606 and a transaction processor 608.

The transaction processor 608 may include an execution unit for executing an identifier rule to record the sending and receiving trader partner's identifiers and qualifiers in the electronic commerce matching service transaction context header. The transaction processor 608 may also include a transaction examiner for examining a sample of the transaction to determine key identifying characteristics, a transaction identifier means for identifying a transaction type using the key identifying characteristics, and a rule processor for applying a rule to the transaction to identify a trade partner, where the rule is chosen from a plurality of rules based upon the transaction type. Other components within transaction processor 608 may include a transaction context header examiner (the transaction context header is a container for transaction context within an electronic commerce systems) for examining information from the electronic commerce service transaction context header and a trade partner identifier for determining an identifier rule to be applied to the transaction to determine a sending and receiving trader partner identity, wherein the identifier class and the transaction type are used to determine the identifier rule, as well as a recorder for recording transaction internal identifiers in an electronic commerce service transaction context header. The transaction processor 608 includes a component for performing many of the functions listed above, commonly known as an adapter. More detail about the adapter component is described below.

A trading partner 620 sends a transaction to trading partner 630 via EBX 600. EBX 600 receives the request from sending trading partner 620 via the Gateway/Delivery Service 606. The transaction processor 606 receives the transaction from the Gateway/Delivery Service 606 and determines the transaction standard, identifies the sending and receiving trade partners 620 and 630, and identifies the transaction type. These results may be passed other components (not shown) within EBX 600 for further processing and actions. The Gateway/Delivery Service 606 then receives the results of the transaction processing and sends the results to the receiving trading partner 630.

A detailed description of one embodiment of the adapter component within the transaction processor 608 is provided below.

### Transaction Identification

The Adapter service performs transaction identification as transactions enter the EBX batch and interactive systems. Transactions are identified by examining a sample of the transaction's data stream or fields in the transaction context header for key identifying characteristics. Once a transaction has been identified, several internal identifiers are recorded in the transaction context header for use by down-stream programs.

Transaction identification logic is configurable through the Adapter's transaction classes. Transaction classes define all the rules used to examine the sample data stream to determine the transaction and the internal identifiers used to identify the transaction.

Configuration

Transaction classes are configured by initialization file parameters. Each transaction class is defined by a separate section in the INI file. Transaction class sections follow the naming format [ADAPT-TXNCLASS-<TxnClassName>], where <TxnClassName> is a unique transaction class name assigned to the transaction class.

[ADAPT-TXNCLASS-<TxnClassName>] Sections

These sections contain all the transaction identification rules and internal identifiers for a transaction class.

TxnClassName: [A-Z, a-z, 0-9, ‘_’], length 1-30

Keywords

Rulen=<RuleExpression>

This keyword specifies an expression, called a rule, that will be evaluated to true or false. The rule can then be used as part of a formula expression to identify a transaction class. n is a numeric counter. Multiple rule keywords may be specified by incrementing the counter n) e.g., Rule01, Rule02, etc.) All rule expressions follow the format:

<LeftOperand><EqualityOperator><RightOperand> When executed, the rule's <LeftOperand> is compared to its <RightOperand> to test the validity of the relationship. The entire rule expression is evaluated to true or false.

Operands

Operands are specified as value expressions. Value expressions may be specified in a number of ways.

Equality Operators

Equality operators test the equality or non-equality of the right and left operands. Equality operators can either be a ‘=’ to test for equality or a ‘!=’ to test for non-equality. When two strings are compared, the comparison is case-insensitive.

At least one rule is required in this embodiment. There is no default.

Formula=<FormulaExpression>

This keyword specifies an expression, called a formula, that will be evaluated to true or false. If the formula is true then the transaction will be identified by the transaction class. A formula expression is one or more rules separated by zero or more logical operators. Expressions within the formula may be grouped by enclosing them in parentheses. All formula expressions follow the formats:

<Rule>

or

<Rule><LogicalOperator><Rule> . . .

Rules

Rules are specified by the Rulen keyword name where each was assigned. Any Rulen keyword name may be used in a formula expression as long as it was specified in the same [ADAPT-TXNCLASS-<TxnClassName>] section as the Formula keyword.

Logical Operators

Logical operators combine multiple expressions. An “AND” operator requires both the left and the right expressions to be true for the combined expression to be true. An “OR” operator requires either the left or right expression, or both expressions, to be true for the combined expression to be true. Many expressions can be combined using multiple logical operators.

This operator is required in this embodiment and there is no default.

TxnId=<ValueExpression>

This keyword specifies the TxnId value that will be recorded in the transaction context header if a transaction is identified by this transaction class. The TxnId value is specified as a value expression so it may be specified in a number of ways, see VALUE EXPRESSIONS. When the TxnId is resolved as a value expression it must be between 1 and 8 alphanumeric characters. If the resolved value exceeds 8 characters a run-time system error will be recorded. If the TxnId value expression is specified as a literal, the TxnId value along with the TxnVersion value (specified in the TxnVersion keyword) must be present in the SETX table of the security database. The Adapter will perform the SETX lookup at program startup and generate a system error if an SETX record is not present.

This keyword is required in this embodiment and there is no default. It should be configured as a value expression and the resolved value should have [A-z, a-z, 0-9], length 1-8.

TxnVersion=<ValueExpression>

This keyword specifies the TxnVersion value that will be recorded in the transaction context header if a transaction is identified by this transaction class. The TxnVersion value is specified as a value expression so it may be specified in a number of ways, see VALUE EXPRESSIONS. When the TxnVersion is resolved as a value expression it must be between 1 and 4 alphanumeric characters. If the resolved value exceeds 4 characters a run-time system error will be recorded. If the TxnVersion value expression is specified as a literal, the TxnVersion value along with the TxnId value (specified in the TxnId keyword) must be present in the SETX table of the security database. The Adapter will perform the SETX lookup at program startup and generate a system error if an SETX record is not present.

This keyword is required in this embodiment and there is no default. This keyword should be configured as a value expression and the resolved value should have [A-z, a-z, 0-9], length 1-4.

FormatType=<ValueExpression>

This keyword specifies the FormatType value that will be recorded in the transaction context header if a transaction is identified by this transaction class. The FormatType value is specified as a value expression so it may be specified in a number of ways. When the FormatType is resolved as a value expression it must be between 1 and 4 alphanumeric characters. If the resolved value exceeds 4 characters a run-time system error will be recorded.

The FormatType of X12 transactions is based on the X12 transaction set version. A cross-reference table may be used to describe the FormatType value expression for X12 transactions.

This value is required in this embodiment unless in TxnIdentificationOnly mode. There is no default and it should be configured as a value expression, the resolved value should have [A-z, a-z, 0-9], and length 1-4.

TestProductionIndicator=>ValueExpression>

This keyword specifies the TestProductionIndicator value that will be recorded in the transaction context header if a transaction is identified by this transaction class. The TestProductionIndicator value is specified as a value expression so it may be specified in a number of ways. When the TestProductionIndicator is resolved as a value expression it must be one alphanumeric character. If the resolved value exceeds one character, a run-time system error will be recorded.

This keyword is required in this embodiment unless operating in the TxnIdentificationOnly mode. There is no default value and the keyword should be configured as a value expression, the resolved value should have [A-z, a-z, 0-9], and the length is 1.

DirectionIndicator=<ValueExpression>

This keyword specifies the DirectionIndicator value that will be recorded in the transaction context header if a transaction is identified by this transaction class. The DirectionIndicator value is specified as a value expression so it may be specified in a number of ways. When the DirectionIndicator is resolved as a value expression, it must be one alphanumeric character. If the resolved value exceeds one character, a run-time system error will be recorded.

This keyword is required unless operating in TxnIdentificationOnly mode. There is no default value for this keyword it should be configured as a value expression, the resolved value should have [A-z, a-z, 0-9], and the length should be one.

StripCharacters=,AsciiDecimalCode>,<AsciiDecimalCode>, . . .

This keyword specifies one or more characters to strip from the transaction's sample data stream after the transaction has been identified. Characters will be stripped from the sample data stream in the DATA00 segment of the transaction context header. Stripping characters affects logic that extracts data from the sample data based on data offsets. It does not affect the transaction identification logic because the transaction must be identified before the sample data may be stripped. Characters to be stripped are specified by their ASCII decimal values so that control characters may be stripped. More than one character may be specified by separating the characters with commas. A keyword value of ControlCharacters may be specified for this keyword to strip all control characters from the data stream. Control characters are ASCII decimal characters 0-31 and 127.

This keyword is optional in this embodiment. There is no default value, 0-127 or Control Characters.

### Trade Partner Identification

The Adapter service performs trade partner identification after a transaction has been identified by a transaction class. Trade partner identification logic is configurable through the Adapter's trade partner identifier classes (identifier class) and rules (identifier rule). Trade partner identification is a three-step process.

Step one examines a few pieces of information from the transaction context header and determines an identifier class. Step two uses the identifier class along with the transaction type (obtained from the previously determined transaction class) to determine a rule that dictates a set of logic to be performed to determine the sending and receiving trade partner's identifiers and qualifiers. Finally, step three executes the identifier rule, which, when completed, records the sending and receiving trade partner's identifiers and qualifiers in the transaction context header in a form that can be used to validate security in the security tables by the Gateway service.

Step One: Determine Trade Partner Identifier Class

An identifier class categorizes a subset of trade partners so that identifiers rules may be applied to the class to make the class compliant with security standards contained in the security database. Trade partners that do not require special identifier rules need not be classified into an identifier class. Identifier class should not be confused with capability class. Capability class describes the transaction processing characteristics for a subset of trade partners, while identifier class describes trade partner identifier and qualifier characteristics for a subset of trade partners.

Identifier classes are created when a subset of trade partners is identified whose identifiers and qualifiers do not conform to security standards. An identifier class' identifiers and qualifiers are either not present in the transaction data or are present but incompatible with security standards. Identifier classes should be created so that a single transaction type rule can be applied to the whole class without exception. If exceptions to the class are found, a new class should be created.

Identifier classes are identified by a key composed of one or more field values in the transaction context header. For example, an identifier class key might be the Fib0HostName=“ECMS-BBS-P001” and Fib0UserId=“123456789”. In addition to transaction context header field values, several special values can be determined by a database lookup in the security database. Valid identifier class key components are discussed later.

A transaction that meets an identifier class key will be subject to a rule to determine the trade partner's identifiers and qualifiers. A transaction that does not meet an identifier class key will be subject to a general default rule.

Step Two: Determine Trade Partner Identifier Rule

Once an identifier class has been identified, it will be used to locate a rule for the identifier class and transaction type. The rule will indicate where to find the identifiers and qualifiers if they are in the data, or specify them in the rule itself.

Step Three: Execute Trade Partner Identifier Rule

Once an identifier rule has been identified, it will be executed. Identifiers and qualifiers will be extracted from the data or extracted from the rule itself, and recorded in the transaction context header in a form that can be used to validate security in the security tables by the Gateway service.

Configuration

Identifier classes are configured by INI file parameters. Each identifier class is defined by a separate section in the INI file. Identifier class sections follow the naming format [ADAPT-IDCLASS-<IdClassName>], where <IdClassName> is a unique identifier class name assigned to he identifier class.

Each identifier rule is defined by a separate section in the INI file. Identifier rule sections follow the naming format [ADAPT-IDRULE-*], where * is a unique combination of TransactionId, TransactionVersion, and identifier class assigned to the identifier rule.

[ADAPT-IDCLASS-<IdClassName>] Sections

The [ADAPT-IDCLASS-<IdClassName>] sections contain all the rules for an identifier class in the format IdClassName: [A-z, a-z, 0-9, ‘_’], length 1-30. The keywords for this section are described below.

Rulen=<RuleExpression>

This keyword specifies an expression, called a rule, that will be evaluated to true or false. The rule can then be used as part of a formula expression to identify a transaction class. n is a numeric counter. Multiple rule keywords may be specified by incrementing the counter n (e.g., Rule01, Rule02, etc.). all rule expressions follow the format:

<LeftOperand><EqualityOperator><RightOperand>

When executed, the rule's <LeftOperand> is compared to the rule's <RightOperand> to test the validity of the relationship. The entire rule expression is evaluated to true or false.

Operands

Operands are specified as value expressions. Value expressions may be specified in a number of ways as discussed further below.

Equality Operators

Equality operators test the equality or non-equality of the right and left operands. Equality operators can either be a ‘=’ to test for equality or a ‘!=’ to test for non-equality. When two strings are compared, the comparison is case-insensitive. At least one rule is required in this embodiment and there is no default.

Formula=<FormulaExpression>

This keyword specifies an expression, called a formula, that will be evaluated to true or false. If the formula is true then the transaction will be classified by the identifier class. A formula expression is one or more rules separated by zero or more logical operators. Expressions within the formula may be grouped by enclosing them in parentheses. All formula expressions follow the formats:

<Rule>

or

<Rule><LogicalOperator><Rule>. . .

Rules

Rules are specified by the Rulen keyword name where each was assigned. Any Rulen keyword name may be used in a formula expression as long as it was specified in the same [ADAPT-TXNCLASS-<TxnClassName>] section as the Formula keyword.

Logical Operators

Logical operators combine multiple expressions. An “AND” operator requires both the left and the right expressions to be true for the combined expression to be true. An “OR” operator requires either the left or right expression, or both expressions, to be true for the combined expression to be true. Many expressions can be combined using multiple logical operators. This operator is required in this embodiment and there is no default value.

[ADAPT-IDRULE-*] Sections

A number of sections can be specified to describe the identifier rules used to determine the identifiers and qualifiers by transaction type. Each transaction type is known to as a TransactionId and TransactionVersion. TransactionIds are unique, but may have several TransactionVersions. [ADAPT-IDRULE-*] sections are always created for a TranscationId but may be further qualified by specifying a TransactionVersion and/or an identifier class. This qualification leveling allows rules to be applied from very general to very specific situations. Before a rule is to be determined, the TranswactionId, TransactionVersion, and identifier class (if any) must be known. The rule location process looks for a rule at the most specific qualification and steps down levels of qualification until a rule is located. [ADAPT-IDRULE-*] sections will be searched in the following order:

[ADAPT-IDRULE-<TransactionId>/<Transaction Version>/<IdClassName>]

[ADAPT-IDRULE-<TransactionId>/<IdClassName>]

[ADAPT-IDRULE-<TransactionId>/<Transaction Version>]

[ADAPT-IDRULE-<TransactionId>]

TransactionId is the system assigned transaction type identifier. TransactionVersion is the system assigned transaction type version. IdClassName is the name of the identifier class.

Keywords

SenderQualifier=<ValueExpression>

This keyword specifies the SenderQualifier value that will be recorded in the transaction context header. The SenderQaulifier value is specified as a value expression so it may be specified in a number of ways. When SenderQualifier is resolved as a value expression, it must be between 1 and 3 alphanumeric characters. If the resolved value exceeds 3 characters, a run-time system error will be recorded. This keyword is required in this embodiment and there is no default value. This keyword is configured as a value expression, the resolved value should have [A-z, a-z, 0-9], and a length 1-3.

SenderId=<ValueExperssion>

This keyword specifies the SenderId value that will be recorded in the transaction context header. The SenderId value is specified as a value expression so it may be specified in a number of ways. When SenderId is resolved as a value expression, it must be between 1 and 40 alphanumeric characters. If the resolved value exceeds 40 characters, a run-time system error will be recorded. This keyword is required in this embodiment and there is no default value. This keyword should be configured as a value expression, the resolved value should have [A-z, a-z, 0-9], and the length 1-40.

ReceiverQaulifier=<ValueExpression>

This keyword specifies the RecieverQualifier value that will be recorded in the transaction context header. The ReceiverQualifier value is specified as a value expression so it may be specified in a number of ways. When ReceiverQualifier is resolved as a value expression, it must be between 1 and 3 alphanumeric characters. If the resolved value exceeds 3 characters, a run-time system error will be recorded. This keyword is required in this embodiment and there is no default value. This keyword should be configured as a value expression, the resolved value should have [A-z, a-z, 0-9], and the length is between 1 and 3 alphanumeric characters.

ReceiverId=<ValueExpression>

This keyword specifies the ReceiverId value that will be recorded in the transaction context header. The ReceiverId value is specified as a value expression so it may be specified in a number of ways. When ReceiverId is resolved as a value expression, it must be between 1 and 40 alphanumeric characters. If the resolved value exceeds 40 characters, a run-time system error will be recorded. This keyword is required in this embodiment and there is no default value. This keyword should be configured as a value expression, the resolved value should have [A-z, a-z, 0-9], and the length should be between 1 and 40 alphanumeric characters.

### Error Handling

The Adapter, like any service, is likely to encounter errors during its execution. However, because the Adapter service operates in both the batch and interactive architectures, it is expected to handle some errors differently.

The Adapter services encounters two types of errors: system and data errors. System errors are caused by improper configuration, system problems, and program bugs. System errors are considered a failure of system services. As such, customers are best served by handling these errors internally without customer intervention. The batch architecture provides error queues and repeatable operations to handle system errors. The interactive architecture, being a real-time architecture, is required to immediately report system errors to the submitter. In both architectures, the caller of the Adapter service (i.e., QManager or Router) is responsible for handling the error. The Adapter simply records the error in the EMS system and returns the error to the caller.

Data errors are caused by the invalid transaction data. The Adapter, tasked with transaction identification, encounters invalid transaction data frequently. In both architectures, data errors, cause a transaction to switch to a different transaction routing state. The error state will cause services to format an appropriate response to the submitter. The method of changing the transaction routing state is different in the two architectures. In the batch architecture, the QManager calls the Adapter service. When the Adapter encounters a data error, it is expected to change the routing state in the transaction context header via the QManager Error Application Programming Interface (API). Once the routing state has been changed, the Adapter returns the transaction context header to the QManager with no error. The QManager then recognizes the routing state change via the QManager Router API. In the interactive architecture, system and data errors are handled identically. When the Adapter encounters a data error, it is expected to return an error in the transaction context header to the Router.

Configuration

Error handling as well as all global parameters are configured in the [ADAPTER] section of the INI file.

Keywords

RunMode=<Batch|Interactive>

This keyword specifies the architecture, and thus the error handling, for the Adapter service. This keyword is required in this embodiment an there is no default value. The valid values are Batch and Interactive.

TxnClassCollisionCheckAction=<Error|None|Warn>

This keyword specifies the action to be performed when a transaction class collision occurs. Transaction classes contain a set of configurable transaction identification rules. It is possible for a run-time transaction to be identified by more than one transaction class. This situation is called a transaction class collision. If Error is specified, the collision causes a critical error to be logged in the EMS system and a system error is returned to the caller. If None is specified, the first transaction class (in alphabetical order) that identifies the transaction is used and no warnings or errors are logged in the EMS system. If Warn is specified, the collision causes the first transaction class (in alphabetical order) that identifies the transaction is used and a non-critical error to be logged in the EMS system. This keyword is required in this embodiment and the default value is “Error”. Valid values are Error, None, and Warn.

IdClassCollisionCheckAction=<Error|None|Warn>

This keyword specifies the action to be performed when an identifier class collision occurs. Identifier classes contain a set of configurable trade partner classification rules. It is possible for trade partners in a run-time transaction to be classified by more than one identifier class. This situation is called an identifier class collision. If Error is specified, the collision causes a critical error to be logged in the EMS system and a system error is returned to the caller. If None is specified, the first identifier class (in alphabetical order) that classifies the trade partners is used and no warnings or errors are logged in the EMS system. If Warn is specified, the collision causes the first identifier class (in alphabetical order) that classifies the trade partners is sued and a non-critical error to be logged in the EMS system. This keyword is required and the default value is “Error”. The valid values are Error, None, and Warn.

BatchDataERrorRouteState=<ValueExpression>

This keyword specifies the new transaction routing state when data errors are encountered in the batch architecture. The value is specified as a value expression so it may be specified in a number of ways. When BatchDataErrorRouteState is resolved as a value expression, it must be between 1 and 8 alphanumeric characters. If the resolved value exceeds 8 characters, a run-time system error will be recorded. This keyword is required and there is no default value. This keyword should be configured as a value expression, the resolved value should have [A-z, a-z, 0-9], the length is between 1 and 8 characters.

InteractiveCheckPOintCollectorName=<InteractiveCheckPOintCollectorNameValue>

This keyword specifies the logical name of the Collector process that should be used to write the interactive check point record. Interactive check point records are snap shots of the transaction context header that are always recorded by the Adapter if RunMode=Interactive. This keyword is required in this embodiment if RunMode=Interactive and there is no default value. The keyword resolved value should have [A-z, a-z, 0-9] and the length is between 1 and 12 characters.

InteractiveCheckPointCollectorRecordName=<InteractiveCheckPOintCollectorRecordNameValue>

This keyword specifies the collector record name for interactive check point records. This keyword is required in this embodiment if RunMoOde=Interactive and there is no default value. This keyword's resolved value should have [A-z, a-z, 0-9] and a length between 1 and 12 characters.

### Value Expressions

A value expression is an expression that is resolved to a single value. The value expression is resolved at program startup or run-time depending on the availability of the expression's elements. The resolved value may be used in another expression or assigned to an entity. The Adapter uses value expressions in rule expressions and for keyword value specification.

Value expressions can be specified directly as a literal or portion or a run-time data area. The resolved value may be passed into a cross-reference table for further resolution.

Literals

Literals are quoted strings containing one or more characters surrounded by double quotation marks (e.g. “Adapter”). All characters within the quotes are considered part of the literal. Therefore, “Adapter” is not equal to “Adapter”. Literals are resolved at program startup.

A literal may also be expressed by specifying the ASCII decimal character codes of the literal. This is useful if the literal must contain special characters.

ASCII(<AsciiDecimalCode>,<AsciiDecimalCode>, . . . )

Where: <AsciiDecimalCode> is a valid ASCII character decimal value (1-27).

### EXAMPLES

“Adapter”

“This is a literal even though it contains spaces”

“0001”

“ ”

ASCII(02)

ASCII(02, 03)

Run-Time Data Areas Run-time data areas may be used in value expressions, but can only be resolved at run-time. There are five run-time data areas: HDR00, FIB0, SampleData, X12Data, and EdifactData.

HDR00

The HDR00 data area may be used to reference data within HDR00 segment of the transaction context header. HDR00 data is specified as a non-EDI data area expression.

FIB0

The FIB0 data area may be used to reference data within FIB0 structure of the DATA00 segment of the transaction context header. FIB0 data is specified as a non-EDI data area expression.

SampleData

The SampleData data area may be used to reference the data within the transaction sample data that is appended to the end of the DATA00 segment of the transaction context header. Sample data is specified as a non-EDI data area expression.

X12Data

The X12Data data area may be used to reference the data within the transaction sample data that is appended to the end of the DATA00 segment of the transaction context header. The X12Data data area should only be used on transactions that are known to contain X12 data. X12 data is specified as an EDI data area expression.

EdifactData

The EdifactData data area may be used to reference the data within the transaction sample data that is appended to the end of the DATA00 segment of the transaction context header. The EdifactData data area should only be used on transactions that are known to contain EDIFACT data. EDIFACT data is specified as an EDI data area expression.

Non-EDI Data Area Expressions

Non-EDI data areas do not conform to a well-defined EDI data type. These data areas are either proprietary fixed-length or simple variable length structures.

If the data areas contains fixed length fields, it should be referenced with a starting byte offset and byte length. Data area, offset, and length are specified like so:

<DataArea>(<Offset>: <Length>)

where: <DataArea> is a run-time data area HDR00, FIB0, or Sample Data; <Offset> is a starting byte offset within the run-time data area; and <Length> is the byte length.

If the data area contains variable length fields, it should be referenced with an ordinal field number and field delimiter. The field delimiter may be obtained from the data area if it is found at a specified offset, or it may be specified directly with its decimal ASCII code. Data area, ordinal field number, and field delimiter are specified like so:

<DataArea>(Field<OrdinalFieldNumber>:<DelimiterOffset>)

or

<DataArea>(Field<OrdinalFieldNumber>:Ascii<DelimiterASciiDecimalCode>)

where: <DataArea> is a run-time data area HDR00, FIB0, or Sample Data; <OrdinalFieldNumber> is the field number with the data area, field numbers are numbered starting with 1; <DelimiterOffset> is the byte offset with the data area where the field delimiter is found; and <DelimiterAsciiDecimalCode> is the ASCII decimal code for the field delimiter.

Non-EDI data area formats are not affected by whitespace or capitalization.

### EXAMPLES

| | |
|---|---|
| Fib0(6:8) | BatchId field of the FIB0 segment; |
| SampleData(Field2:Ascii44) | Field 2 in the sample data, the field |
| | delimiter is ASCII decimal characters; |
| SampleData(Field4:1) | Field 4 in the sample data, the field |
| | delimiter is found at offset 1 in the data; |
| Hdr00(290:4) | ConractNum field of the HDR00 segment |

EDI Data Area Expressions

EDI data areas are well-defined EDI data types. The Adapter can handle X12 and EDIFACT EDI data.

EDI data is reference by segment, element, and optionally composite element. In addition, portions of an EDI element may be referenced by specifying a starting byte offset within the element and byte length. EDI data area expression are specified like so:

<DataArea>(<Segment>-<Element>[\hat{ }<Compositeelement>][[<Offset>:<Length]])

where: <DataArea> is a run-time data area, X12Data, or Edifact Data; <Segment> is the name of the EDI segment; <Element> is the number of he element within the segment, element numbers start at 1 (segment name isn't numbered); <CompositeElement> is the number of the composite element within the element, composite element numbers start at 1; <Offset> is a starting byte offset within the segment; and <Length> is the byte length or ‘*’ which indicates the remaining field width of the EDI field.

When a segment is referenced in EDIO data, the Adapter will use the first occurrence of the segment to resolve the expression. The segment referenced in EDI data area formats are not affected by whitespace or capitalization.

### EXAMPLES

| | |
|---|---|
| X12ata(GS-08[0:6]) | First 6 bytes of the Version element |
| | of the GS segment of the X12 data; |
| X12Data(GS-08[2:*]) | Bytes 3 through the end of the Version |
| | element of the GS segment of the X12 |
| | data; |
| X12Data(ISA-05) | InterchagnedIdQualifier element of the |
| | ISA segment of the X12 data; |
| EdifactData(UIB-06\hat{ }02) | Second composite element of the |
| | SenderIdentification element of the |
| | UIB segment of the EDIFACT data. |

### Cross-Reference Tables

A Value resolved from a predefined data area may be passed into a cross-reference table to further resolve the value expression. A cross-reference table accepts an entry value and uses it to find a record in the cross-reference table with a key matching the entry value. Each record in the cross-reference table contains an entry value and a cross-reference value that will be returned as the result.

Configuration

Cross-reference tables are configured by INI file parameters. Each cross-reference table is defined by a separate section in the INI file. Cross-reference sections follow the naming format [ADAPT-XREFTABLE-<XrefTableName>], where <XrefTableName> is a unique cross-reference table name assigned to the table.

[ADAPT-XREFTABLE-<XrefTableName>] Sections

These sections contain all entries for a cross-reference table. The format for XrefTableName is [A-z, a-z, 0-9, ‘_’] with a length between 1 and 30 alphanumeric characters.

Keywords

Default=<DefaultReturnValue>

This keyword specifies the return value if a cross-reference record for the entry value is not specified. This keyword is optional in this embodiment and there is no default value. Any ASCII character except control characters and ‘,’ are acceptable and the length is between 1 and 30 alphanumeric characters.

Xrefn=<EntryValue>,<ReturnValue>

This keyword specifies a cross-reference record with an entry value and return value. n is a numeric counter. Multiple keywords may be specified by incrementing the counter n (e.g. Xref01, Xref02, etc.). The entry value and return value are separated by a comma. This keyword is required in this embodiment for each desired cross-reference entry and there is no default value. The entry and return values may contain any ASCII character except control characters and ‘,’ and have length between 1 and 30 alphanumeric characters.

Usage

Cross-reference tables are referenced by name. They may be used in value expressions like so: <XrefTableName>(<ValueExpression>)

### EXAMPLE

X12FORMATTYPE(X12Data(GS-08[0:6])) Pass the first 6 bytes of the 8^{th} element in the GS segment (Version) of the X12 transaction into the X12FORMAT|TYPE cross-reference table.

### Trace Facility

The Adapter trace facility may be used to report run-time events as transactions pass through the Adapter. Tracing is most appropriate for testing and certification environments, where new transactions and trading partners are certified. Tracing is done on a single Adapter process, so if multiple Adapter processes are running in a pool, the Adapter trace may not see all the traffic running through the environment.

Multiple traces may be active in a single Adapter process at the same time as long as they are directed to different trace files.

Starting a Trace

An Adapter trace is started using the XCSENDER utility. The command string is:

XCSENDER<adapter-process-name>−c TraceStart-f<trace-file>[−t<trace-time>][−v]

where <adapter-process-name> is required and specifies the Guardian process name of the Adapter process to trace; −f<trace-file> is required and specifies the name of an edit file, spooler file, or terminal to which tracing messages will be directed; −t<trace-time> is optional and specifies the number of minutes tracing will be active, valid values are 1-60, the default is 10 minutes; and −v is optional and turns on verbose tracing with the default set as off.

Considerations

If tracing is to be recorded in an edit file, the edit file name in the <trace-file> parameter must not currently exist. If it does, the Adapter will return an error to XCSENER and the trace will be ignored. If the edit file fills up, the Adapter will log a non-critical error and stop the trace.

If tracing is to be directed to a terminal, the terminal should be in a paused state. If the terminal is not in a paused state, the trace writes will timeout.

If any trace writes timeout, the Adapter will log a non-critical error and automatically stop the trace.

Stopping a Trace

Adapter traces are normally stopped when the trace time expires. However, traces may be stopped manually with an XCSENDER command. The command string is:

XCSENDER<adapter-process-name>−c TraceStop-f<trace-file>

Considerations

If the trace begin stopped does not exist, the Adapter will return an error to XCSENDER.

### Report Facility

The Adapter keeps internal reporting statistics. The reporting statistics are collected for each day. A daily report can be requested on demand or configured to be written out to a spooler at the end of each day.

Retrieving a Report

An Adapter daily report is retrieved using the XCSENDER utility. The command string is:

XCSENDER<adapter-process-name>−c Daily Report-f<report-file>

where <adapter-process-name> is required and specifies the Guardian process name of the Adapter process to trace; and −f<report-file> is required and specifies the name of an edit file, spooler file, or terminal to which the daily report will be written.

Considerations

If the daily report is to be recorded in an edit file, the edit file name in the <report-file> parameter must not currently exist. If it does, the Adapter will return an error to XCSENDER and the request will be ignored.

If the daily report is to be directed to a terminal, the terminal should be in a paused state. If the terminal is not in a paused state, the report writes will timeout and the request will be canceled.

Configuration

The report parameters are configured in the [ADAPTER] section of the INI file.

Keywords

DailyReportSpoolerName=<DailyReportSpoolerNameValue>

This keyword specifies a valid spooler name to which daily reports will be written at the end of each day. Daily reports will have the following naming convention:

<DailyReportSpoolerName>.#ADAPT.Rmmddyy

This keyword is optional in this embodiment and does not have a default value.

### Special Modes

Several special modes may be set in the Adapter that affect the program's behavior.

ReportOnly Mode

As a promotion and integration testing aid, the Adapter may be configured to run in ReportOnly mode. IN this mode, the Adapter is completely passive. Instead of performing its logical and altering the transaction context header or the transactions, it performs its logical on a private copy of the transaction data and reports on what the Adapter would have done were it fully enabled. The original transaction context header that arrived at the Adapter is simply passed untouched.

TxnIdentificationOnly Mode

In some situations, it is desirable to limit some of the Adapter's processing steps. TxnIdentiicationOnly mode limits the Adapter's processing step to identifying the transaction by evaluating the configured TxnClasses. Any IdClasses and IdRules configured are ignored. This mode is useful to identify transactions that are coming from known sources, such as the interactive response from a foreign host. Sometimes, the host may send more than one type of transaction as a response. The Adapter can identify the transaction.

Configuration

The special mode parameters are configured in the [ADAPTER] section of the INI file.

Keywords

ReportOnlyMode=<Yes|No>

This keyword specifies whether the Adapter will be run in ReportOnly mode. ReportOnly mode is only useful as a testing aid. This keyword is optional in this embodiment, there is no default value, and valid values are “Yes” and “No”.

TxnIdentificationOnlyMode=<Yes|No>

This keyword specifies whether the Adapter will be run in TxnIdentificationOnlyMode mode. This keyword is optional in this embodiment, there is no default value and valid values are “Yes” and “No”.

### Batch Events

If the Adapter service is running in Batch mode (RunMode=Batch), batch events will be logged to the BAP subsystem.

3900 Transaction Identification Success

The transaction identification success event signals the successful identification of the transaction.

3901 Transaction Identification Failure

The transaction identification failure event indicates a transaction could not be identified.

3902 Trade Partner Identification Success

The trade partner identification success event signals the successful identification of a transaction's trade partners.

3903 Trade Partner Identification Failure

The trade partner identification failure event indicates a trade partner class could not be determined for a transaction.

### Errors and Messages

The following section describes the errors that the Adapter service could return to the QManager or Router and EMS messages.

System Errors

The Adapter service records system errors in the EMS system and returns them to the QManager or Router. The Adapter will generate an EMS non-critical or critical error for system errors depending on the severity of the error. IN the batch architecture, these errors are handled by the QManager and its configuration. In the interactive architecture, these errors cause the Router to switch to an error transaction state. A generic system error message will be returned to the submitter.

7360 Memory Allocation Error

This error is usually caused by improper heap size or a memory leak.

7361 Configuration Error

This error is usually caused by invalid or missing keyword values in the INI file. The Adapter verifies its entire configuration at startup, so nearly all configuration errors will be caught before it performs work.

7362 Transaction Class Collision Error

This error occurs when two or more transaction classes identify a run-time transaction. Transaction class collisions only cause an error when the TxnClassCollisionAction keyword is Error or Warning.

7363 Identifier Class Collision Error

This error occurs when two or more transaction classes classify a run-time transaction's trade partners. Identifier class collisions only cause an error when the IdClasscollisionACtion keyword is Error or Warning.

7364 Bad Transaction context header Error

This error occurs when the Adapter program encounters a corrupted transaction context header. These errors are usually caused by a program bug in an up-stream program.

7365 ECMS API Error

This error occurs when the Adapter receives an error from an ECMS API. The cause of the error should be revealed by the documentation and EMS message of the API.

7366 Bad Trace File

This error occurs when a trace start command is received and the supplied trace file is invalid or the wrong type of file. The Adapter reports this error as a non-critical error and ignores the trace start request.

7367 Trace File Write Error

This error occurs when the Adapter encounters an error writing to an active trace file. This is usually caused by a disk trace file being full or a terminal trace file not being in a ready state. IN such cases, the Adapter reports this error as a non-critical error and terminates the trace file.

7368 Bad Server Command Error

This error occurs when an invalid command is issued to the Adapter service. The Adapter reports the error as a no-critical error.

7369 Cross-Reference System Error

This error occurs when a value-expression not related transaction or trade partner identification cannot be resolved because of a cross-reference error.

Data Errors

The Adapter service changes the transaction routing state when data error occur in the batch architecture. In the interactive architecture, the Adapter returns the data error to the Router. The Adapter always generates an EMS non-critical error for data errors.

7370 Transaction Format Error

This error occurs when a transaction was identified by a transaction class, but a problem with the transaction's structure prevented the Adapter from completing the transaction identification or grade partner identification process.

7371 No Transaction Class Error

This error occurs when a transaction could not be identified with a transaction class. The error is usually caused by the submission of an invalid transaction.

7372 Cross-Reference Data Error

This error occurs when a value-expression related to trade partner identification cannot be resolved because of a cross-reference error.

9997 No Transaction Class (unrecognized transaction) Error

All data errors are rolled-up to the following generic unrecognized transaction error code. This error code will be reported back to the QManager or Router if a data error occurs. The other data error codes will only appear in the EMS message.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for identifying and classifying electronic commerce transactions, the method comprising:
receiving a transaction;
examining a sample of the transaction to determine key identifying characteristics;
identifying a transaction type using the key identifying characteristics; and
applying a rule to the transaction to identify a trade partner, where the rule is chosen from a plurality of rules based upon the transaction type.

2. The method as recited in claim 1, wherein the sample of the transaction comprises a sample of a data stream of the transaction.

3. The method as recited in claim 1, wherein the sample of the transaction comprises at least one field in a transaction context header of the transaction.

4. The method as recited in claim 1, further comprising:
recording transaction internal identifiers in an electronic commerce matching service transaction context header.

5. The method as recited in claim 4, further comprising:
examining information from the electronic commerce matching service transaction context header; and
using the identifier class and the transaction type to determine an identifier rule to be applied to the transaction to determine a sending and receiving trader partner identity.

6. The method as recited in claim 5, further comprising:
executing the identifier rule to record the sending and receiving trader partner's identifiers and qualifiers in the electronic commerce matching service transaction context header.

7. The method as recited in claim 6, wherein the trader partner's identifiers and qualifiers are recorded in the electronic commerce matching service transaction context header in a form that can be used to validate security.

8. A system for identifying and classifying electronic commerce transactions, the system comprising:
receiving means for receiving a transaction;
transaction examining means for examining a sample of the transaction to determine key identifying characteristics;
transaction identifying means for identifying a transaction type using the key identifying characteristics; and
applying means for applying a rule to the transaction to identify a trade partner, where the rule is chosen from a plurality of rules based upon the transaction type.

9. The system as recited in claim 8, wherein the sample of the transaction comprises a sample of a data stream of the transaction.

10. The system as recited in claim 8, wherein the sample of the transaction comprises at least one field in a transaction context header of the transaction.

11. The system as recited in claim 8, further comprising:
recording means for recording transaction internal identifiers in an electronic commerce matching service transaction context header.

12. The system as recited in claim 11, further comprising:
transaction context header examining means for examining information from the electronic commerce matching service transaction context header; and
trade partner identification means for using the identifier class and the transaction type to determine an identifier rule to be applied to the transaction to determine a sending and receiving trader partner identity.

13. The system as recited in claim 12, further comprising:
executing means for executing the identifier rule to record the sending and receiving trader partner's identifiers and qualifiers in the electronic commerce matching service transaction context header.

14. The system as recited in claim 13, wherein the trader partner's identifiers and qualifiers are recorded in the electronic commerce matching service transaction context header in a form that can be used to validate security.

15. A computer program product in a computer readable media for use in a data processing system for identifying and classifying electronic commerce transactions, the computer program product comprising:
receiving instructions for receiving a transaction;
transaction examining instructions for examining a sample of the transaction to determine key identifying characteristics;
transaction identifying instructions for identifying a transaction type using the key identifying characteristics; and
transaction rule applying instructions for applying a rule to the transaction to identify a trade partner, where the rule is chosen from a plurality of rules based upon the transaction type.

16. The computer program product as recited in claim 15, wherein the sample of the transaction comprises a sample of a data stream of the transaction.

17. The computer program product as recited in claim 15, wherein the sample of the transaction comprises at least one field in a transaction context header of the transaction.

18. The computer program product as recited in claim 15, further comprising:
recording instructions for recording transaction internal identifiers in an electronic commerce matching service transaction context header.

19. The computer program product as recited in claim 18, further comprising:
transaction context header examining instructions for examining information from the electronic commerce matching service transaction context header; and
trade partner identifying instructions for, using the identifier class and the transaction type, determining an identifier rule to be applied to the transaction to determine a sending and receiving trader partner identity.

20. The computer program product as recited in claim 19, further comprising:
executing instructions for executing the identifier rule to record the sending and receiving trader partner's identifiers and qualifiers in the electronic commerce matching service transaction context header.

21. The computer program product as recited in claim 20, wherein the trader partner's identifiers and qualifiers are recorded in the electronic commerce matching service transaction context header in a form that can be used to validate security.

22. A system for identifying and classifying electronic commerce transactions, the system comprising:
a receiver for receiving a transaction;
a transaction examiner for examining a sample of the transaction to determine key identifying characteristics;
a transaction identifier means for identifying a transaction type using the key identifying characteristics; and
a rule processor for applying a rule to the transaction to identify a trade partner, where the rule is chosen from a plurality of rules based upon the transaction type.

23. The system as recited in claim 22, wherein the sample of the transaction comprises a sample of a data stream of the transaction.

24. The system as recited in claim 22, wherein the sample of the transaction comprises at least one field in a transaction context header of the transaction.

25. The system as recited in claim 22, further comprising:
a recorder for recording transaction internal identifiers in an electronic commerce matching service transaction context header.

26. The system as recited in claim 25, further comprising:
a transaction context header examiner for examining information from the electronic commerce matching service transaction context header; and
a trade partner identifier for determining an identifier rule to be applied to the transaction to determine a sending and receiving trader partner identity, wherein the identifier class and the transaction type are used to determine the identifier rule.

27. The system as recited in claim 26, further comprising:
an execution unit for executing the identifier rule to record the sending and receiving trader partner's identifiers and qualifiers in the electronic commerce matching service transaction context header.

28. The system as recited in claim 27, wherein the trade partner's identifiers and qualifiers are recorded in the electronic commerce matching service transaction context header in a form that can be used to validate security.
